(19) United States
(12) Patent Application Publication
(10) Pub. No.: US 2018/0333599 A1
(43) Pub. Date: Nov. 22, 2018

(54) SELF-SEALING SPRINKLER SEAL AND METHODS

(71) Applicant: Tyco Fire Products LP, Lansdale, PA (US)

(72) Inventors: Karl Fredrik Penden, Rumford, RI (US); Yoram Ringer, Providence, RI (US)

(21) Appl. No.: 16/047,436

(22) Filed: Jul. 27, 2018

Related U.S. Application Data
(63) Continuation of application No. 14/896,345, filed on Dec. 4, 2015.
(60) Provisional application No. 61/842,957, filed on Jul. 3, 2013.

(51) Int. Cl. A62C 37/14; A62C 35/68; B05B 1/26; A62C 37/11

(52) U.S. Cl. CPC A62C 37/14; A62C 37/11; B05B 1/265; A62C 35/68

(57) ABSTRACT

An automatic fire protection sprinkler assembly and a method of sealing includes a sprinkler frame having an inlet, an outlet, an internal passageway extending between the inlet and the outlet, and a sealing surface formed about the outlet. The assembly also includes a thermally responsive trigger and a seal assembly disposed between the sealing surface and the thermally responsive trigger. The seal assembly includes a body having an inner surface defining an internal chamber. The inner surface has a portion disposed relative to the sealing surface such that a fluid disposed in the internal chamber and acting on the portion of the inner surface provides a sealing force in the direction of the sealing surface.

### CROSS REFERENCE TO RELATED APPLICATIONS

This application is a continuation of U.S. application Ser. No. 14/896,345, filed Dec. 4, 2015, which is a 371 National Stage Application of International Application No. PCT/US2014/045466, filed Jul. 3, 2014, which claims the benefit of priority to U.S. Provisional Application No. 61/842,957, filed Jul. 3, 2013, all of which are incorporated herein by reference in their entireties.

### TECHNICAL FIELD

The present invention relates generally to fire protection devices, and more specifically, sprinkler assemblies and the arrangement and operation of their components.

### BACKGROUND OF THE INVENTION

Known automatic fire protection sprinklers have a seal assembly, which can includes a sealing plug to seal the internal passageway of the sprinkler, a biasing element such as for example a Belleville spring to bias the assembly open, and a thermally responsive trigger element, such as for example, a glass bulb for loading the plug and Belleville spring into a closed and sealed position. The glass bulb is loaded into position to provide a sealing force against the sealing spring, plug and any fluid pressure upon sprinkler installation. A load screw provides the loading force by leveraging off of the sprinkler frame. Known seal assembly arrangements are shown in U.S. Pat. Nos. 8,074,725; 7,201,234; and 8,151,897.

### DISCLOSURE OF INVENTION

Preferred embodiments of an automatic sprinkler assembly and its method of self-sealing provides for a sprinkler assembly with a seal assembly that has, preferably, a low pre-load force as compared to the pre-load requirements for known sprinkler seal assemblies. The preferred embodiment provides a seal assembly that can be utilized with a thermally responsive trigger assembly that obviates the need for a load screw with the thermally responsive trigger to seal the seal assembly. As such, the preferred embodiment provides for a sprinkler that includes a seal assembly and a non-load-screw thermally responsive trigger.

A preferred embodiment of an automatic fire protection sprinkler assembly include a sprinkler frame having an inlet coupled to a fluid source, an outlet and an internal passageway extending between the inlet and the outlet and a sealing surface formed about the outlet. The assembly further includes a thermally responsive trigger and a seal assembly disposed between the sealing surface and the thermally responsive trigger. The seal assembly preferably has a body having an inner surface defining an internal chamber. The inner surface preferably includes a portion disposed relative to the sealing surface such that a fluid disposed in the internal chamber acts on the portion of the inner surface to define a sealing force in the direction of the sealing surface.

Another preferred embodiment of an automatic fire protection sprinkler assembly includes a sprinkler frame having an inlet, an outlet and an internal passageway extending from the inlet and the outlet with a sealing surface formed about the outlet. The assembly further includes a deflector member spaced from the outlet and a seal assembly for sealing the internal passageway. The seal assembly preferably includes a body having a proximal end, a distal end and a wall circumscribed about a central axis to define an outer surface and an inner surface forming an internal chamber. The wall defines an opening at the proximal end of the body exposing the internal chamber to the internal passageway and a floor at the distal end of the body to enclose the chamber. The sprinkler assembly additionally includes a thermally responsive trigger disposed between the seal assembly and the deflector member to support the seal assembly in the outlet such that a portion of the proximal end of the body engages the sealing surface to form a fluid tight seal with the internal passageway in fluid communication with the internal chamber.

In preferred embodiments, the body of the seal assembly can be made of an elastomeric material, metal, or combinations of an elastomeric material and metal, or any other suitable material to provide the function of the seal assembly; that is, to seal the sealing surface of the outlet and support the thermally responsive trigger. In another preferred embodiment, the body of the seal assembly is symmetrical about a first plane. A second plane intersects the first plane along a central axis to define a bisected body. The bisected body defines a plan cross-sectional profile with a wall having a curve at each end of the profile, and between the proximal end and the distal end of the body the curve has a center of curvature, and preferably, the bisected body defines an oval or elliptical profile. In yet another preferred embodiment, a portion of the outer surface at the proximal end of the body engages the sealing surface such that an internal fluid pressure within the chamber acts on a portion of the inner surface parallel to the portion of the outer surface to define a normal force to the sealing surface.

In still another preferred embodiment, the seal assembly further includes a button having an upper surface and a lower surface. The upper surface of the button has a first recess for housing the body and the lower surface of the button has a second recess that engages the thermally responsive trigger. In still yet another preferred embodiment, the sprinkler frame has an annular groove that forms about the sealing surface and the upper surface of the button is engaged with the annular groove. The thermally responsive trigger is preferably a glass bulb.

A preferred method is provided for sealing an automatic fire protection sprinkler having a sprinkler frame having an inlet, an outlet and a sealing surface surrounding the outlet. The preferred method includes engaging the sealing surface with a seal assembly adjacent the sealing surface; and pressurizing an internal chamber of the body. In another preferred embodiment, a snap fit is formed between the sealing surface and the thermally responsive trigger when the sealing assembly is loaded between the sealing surface and the thermally responsive trigger.

In still another preferred embodiment, the axial distance between the sealing surface and the thermally responsive trigger is less than the height of the sealing assembly when forming the snap fit. The internal chamber has an internal profile which is substantially elliptical and defines a sealing force which is normal to the sealing surface of the sprinkler frame. In another embodiment, the body is housed in a first recess which is formed along the upper surface of the button and seats a thermally responsive trigger in a second recess along the bottom surface of the button.

### BRIEF DESCRIPTION OF DRAWINGS

The accompanying drawings, which are incorporated herein and constitute part of this specification, illustrate exemplary embodiments of the invention, and together, with the general description given above and the detailed description given below, serve to explain the features of the invention. It should be understood that the preferred embodiments are some examples of the invention as provided by the appended claims.

FIG. 1 is a perspective view of a preferred sprinkler assembly;

FIG. 1A is a perspective cross-sectional view of the sprinkler of FIG. 1;

FIG. 1B is a another perspective cross-sectional view of the sprinkler of FIG. 1;

FIG. 2 is a detailed cross-sectional view of a preferred seal assembly for use in the sprinkler assembly of FIG. 1;

FIG. 2A is an exploded perspective view of the preferred seal assembly used in the sprinkler assembly of FIG. 1A;

FIG. 2B is a cross-sectional plane view of the preferred seal assembly of FIG. 2A;

FIG. 2C is a perspective view of another preferred seal assembly used in the sprinkler assembly of FIG. 5;

FIG. 2D is a cross-sectional view of the seal assembly of FIG. 2C;

FIG. 3 is a partial cross-sectional view of the preferred body in the sprinkler assembly of FIG. 1A under fluid pressure;

FIG. 4 is a plan cross-sectional view of the sprinkler assembly of FIG. 1; and

FIG. 5 is a plan cross-sectional view of another preferred embodiment of the sprinkler assembly.

FIG. 5 A is a detailed view of the seal assembly used in FIG. 5.

### MODE(S) FOR CARRYING OUT THE INVENTION

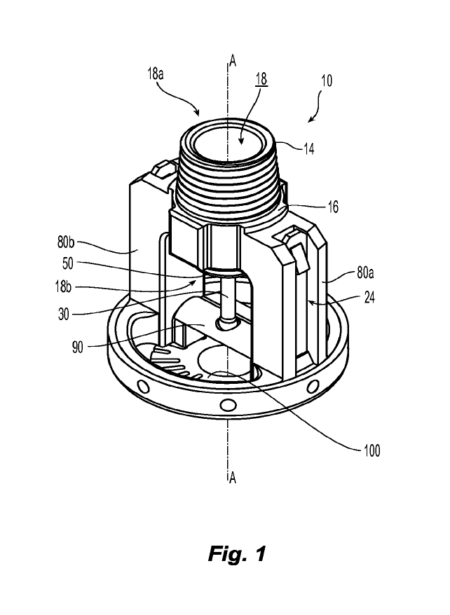

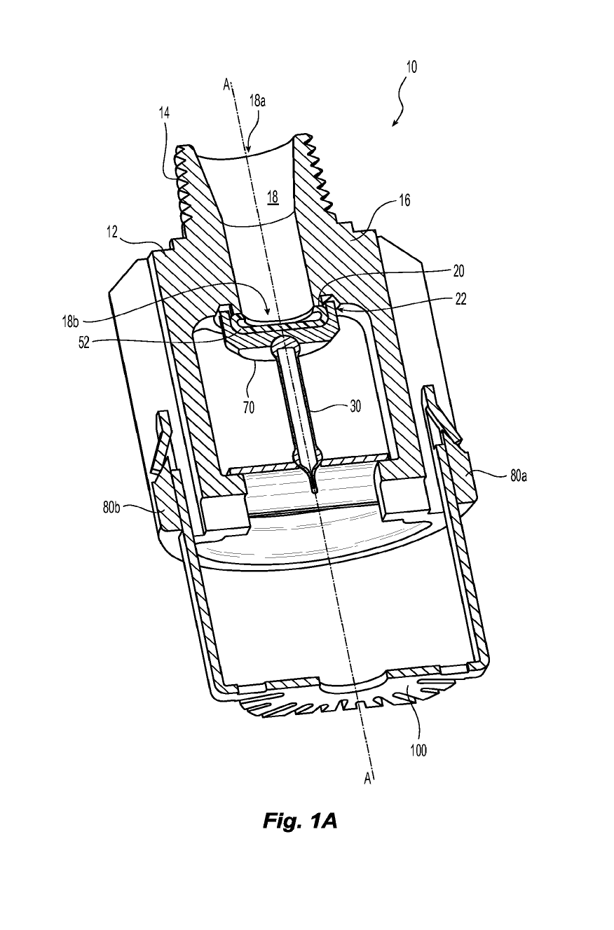

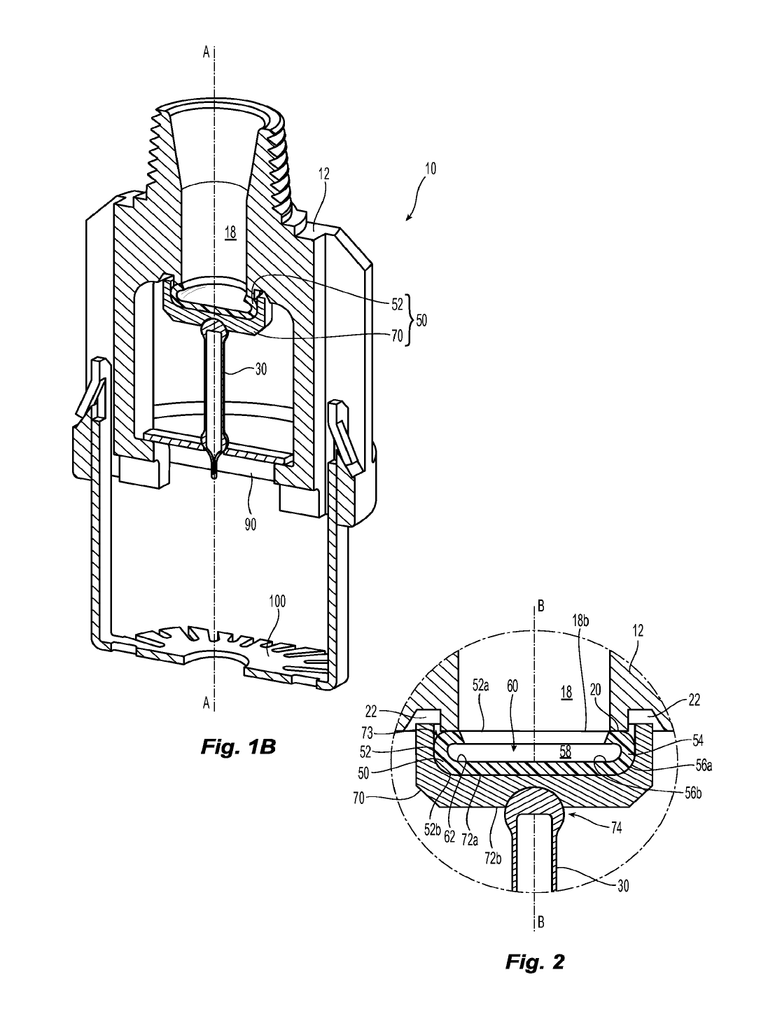

Shown in FIGS. 1 and 1A is an illustrative embodiment of a preferred fire protection sprinkler assembly 10. The preferred assembly 10 includes a sprinkler frame 12 and a deflector assembly 100 engaged with the sprinkler frame 12. The sprinkler frame has a proximal portion 14 for coupling the sprinkler assembly 10 to a fluid supply pipe network and a distal portion 16 for supporting the deflector assembly 100. The proximal portion 14 is configured for receipt of a fire fighting fluid, e.g. water, at the inlet 18a of an internal fluid passageway 18 for discharge from the outlet 18b formed at the distal portion 16 of the sprinkler frame 12. The internal passageway is a preferably tubular to define a longitudinal axis A-A of the sprinkler assembly with an internal diameter that can vary along its length. The sprinkler frame 12 preferably includes a sealing surface 20 surrounding the outlet 18b; and in one aspect preferably includes an annular groove 22 surrounding the sealing surface 20.

The sprinkler assembly 10 includes a thermally responsive trigger assembly 30 to control operation of the sprinkler assembly 10 between an unactuated state and an actuated state. In the unactuated state, the thermally responsive trigger assembly 30 maintains a preferably self-sealing seal assembly 50 to seal the outlet 18b of the sprinkler frame 12. The trigger assembly 30 preferably includes a thermally responsive link or element in the preferred form of a glass bulb 30; however, any suitable thermally responsive link can be utilized for the thermally responsive trigger assembly 30. In response to a sufficient amount of heat from, for example a fire event, the thermally responsive trigger assembly 30 operates to place the sprinkler assembly in an actuated state and release the seal assembly 50 from the outlet 18b. Once actuated, the seal assembly 50 is displaced or ejected and water is discharged from the outlet 18b to impact the deflector assembly 100 for distribution of water in a pattern and/or density for addressing a fire in a desired manner.

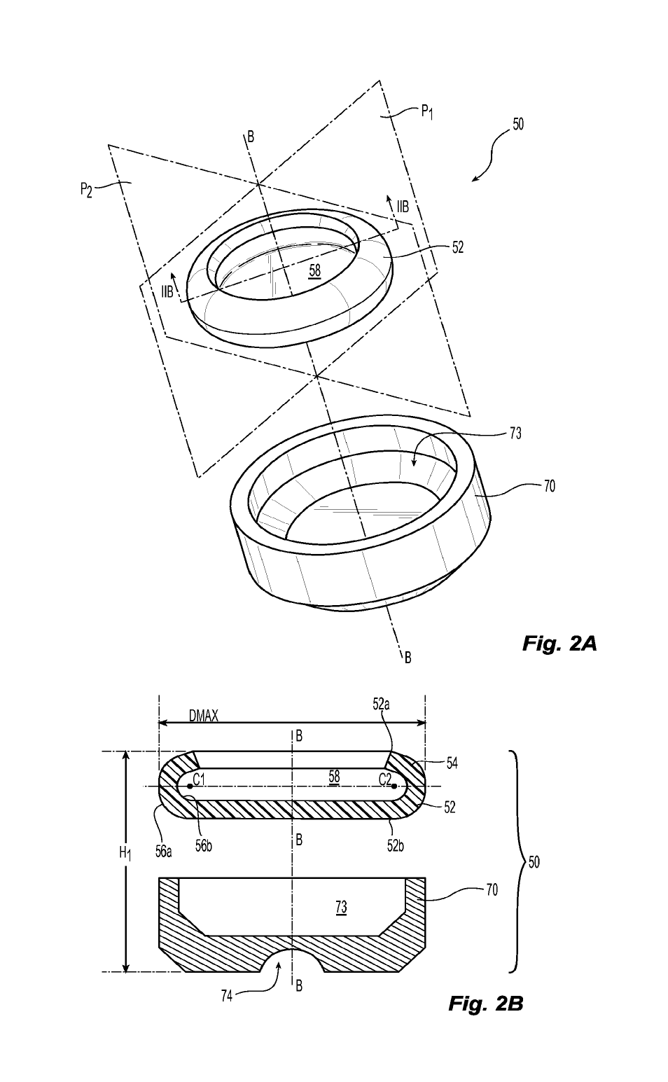

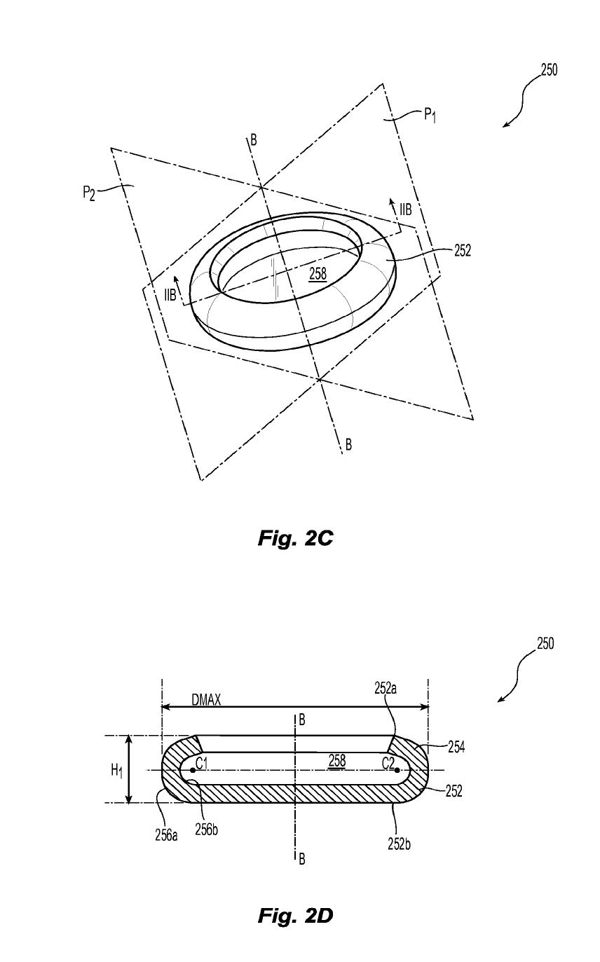

A preferred embodiment of a seal assembly 50 is shown in FIG. 2. The seal assembly 50 includes a body 52 having a proximal end 52a, a distal end 52b and a wall 54 circumscribed about a central axis B-B to define an outer surface 56a and an inner surface 56b forming an internal chamber 58. The wall 54 defines an opening 60 at the proximal end 52a of the body 52 exposing and providing the internal fluid passageway 18 of the frame 12 with fluid access to the internal chamber 58 and a floor 62 at the distal end of the body 52, which encloses the chamber 58. In the unactuated state of the sprinkler assembly 10, the thermally responsive trigger 30 supports and loads the seal assembly 50 in the outlet 18b such that the proximal end 52a of the body 52 engages the sealing surface 20 to expose and place the internal passage 18 of the sprinkler frame 12 in fluid communication with the internal chamber 58 of the body 52.

Shown in FIGS. 2A and 2b are various views of the body 52. The body 52 is preferably symmetrical about a plane passing through the central axis B-B and more preferably symmetrical about a first plane PI and a second plane P2 intersecting the first plane. In one preferred embodiment, the body 52 and its internal chamber 58 define a bowllike geometry. The wall 54 of the body 52 circumscribes the axis B-B such that the outer surface 56a defines a preferably circular geometry having a maximum diameter DMAX. Alternatively, the outer surface 56a can define a non-circular geometry such as for example, rectangular or square defining a maximum width. Referring to the cross-sectional view of FIG. 2B, the wall 54 preferably defines an arcuate sidewall. More preferably, the wall 54 defines an arc of a circle having its center CI disposed between the proximal end 52a and the distal end 52b. Given the preferable symmetry of the body 52, the wall 54 and more particularly the radial sidewalls of the body 52, its inner surface 56b and/or its outer surface 56 preferably defines a substantially oval shape or elliptical profile in a bisected cross-section. The bisected cross-section provides a plan cross-sectional profile with a wall defining curves at each end of the profile. The curves having a center of curvature between the proximal end and the distal end of the body 52.

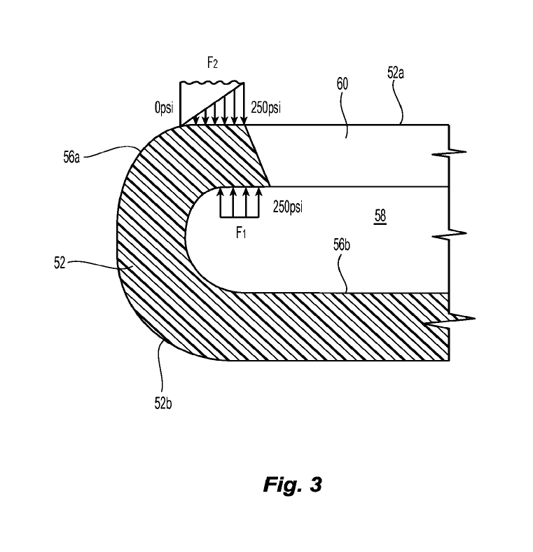

The geometry of the body 52 facilitates the self-sealing nature of the seal assembly 50. More specifically, the inner surface 56b profile redirects fluid pressure within the chamber to define an outwardly directed force that forms a fluid tight seal between the body 52 and the sealing surface 20 of the sprinkler frame 12. Referring to the diagram of FIG. 3, shown is a partial free-body diagram of the body 52 installed in the sprinkler assembly 10 with a fire fighting fluid, e.g., water filling the internal passageway 18 of the sprinkler frame 12 and pressurizing the internal chamber 58 of the body 52. The installed seal assembly 50 and body 52 are preloaded by a loading force (not shown) which is directed in the distal-to-proximal direction. The loading force is a static load preferably applied by the mounted thermally responsive trigger such as, for example, the glass bulb 30. The loading force is preferably sufficient to support the body 52 against the sealing surface 20 of the frame 12 and more preferably compresses the body 52 and deflect the wall 54 to preferably reduce the radius of curvature of the wall 54 of the body 52. In one preferred embodiment, the body 52 is compressed so as to place a portion of the outer surface 56a at or near the proximal end 52a of the body 52 against the sealing surface 20 of the frame 12.

Water delivered to the sprinkler frame 12 flows through the internal passageway 18, out the outlet 18b to pressurize the internal chamber 58 to a pressure. The fluid pressure acts against the inner surface 56b of the body 52 with the fluid force distributed about the inner surface 56b. The internal fluid forces includes forces that act against a portion of the inner surface 56b at or near proximal end 52a of the body 52. Because of the relative positioning of the inner surface 56b at or near the proximal end 52a of the body 52, the fluid forces acting on the inner surface 56b define a sealing force F1. More specifically, the internal forces along the proximal portion of the body 52 are preferably resolved to a sealing force F1 which extends in the distal-to-proximal direction and substantially normal to the sealing surface 20 to form a fluid tight seal in the preferred engagement between the sealing surface 20 and the preferred proximal portion of the outer surface 56a which is preferably parallel to the proximal portion of the inner surface 56b against which the fluid forces acts. The reaction force F2 which acts in the proximal-to-distal direction against the outside surface 56a varies radially in a direction from the opening 60 to the outer lateral sidewall of the wall 54. The reaction force F2 varies of as a function of the pressure on the outer surface 56a of the wall 54, which preferably varies parabolically with a minimum pressure at the outer lateral surface and a maximum pressure toward the central opening 60. Thus, for the exemplary fluid pressure of 250 psi. delivered to the internal chamber 58 shown in FIG. 3, the reaction force F2 is at a maximum pressure of 250 psi. at the opening 60 and decreases to about zero in the outer most lateral direction. In maintaining a fluid tight seal between the body 52 and the sealing surface 20, the sealing force F1 is greater than the reaction force F2. More preferably the forces are related to one another in which the sealing force F1 greater than or about equal to two times the reaction force F2. The magnitude of the sealing force F1 is directly related to the fluid pressure. Accordingly, an increase in the delivered fluid pressure PW increases the sealing force F1. One advantage of the self-sealing nature of the preferred seal assembly 50 and its geometry is that the assembly can maintain a fluid-tight seal even if the body 52 and its central axis B-B is slightly skewed with respect to the longitudinal axis A-A.

In the preferred embodiment described, the geometry of the body 52 facilitates formation of a sealed engagement between a portion of the outer surface 56a of the body 52 and the sealing surface 20 of the frame 12. The proximal end 52a of the body can be alternatively configured to define a flange or other region along the inner surface 56b or between the inner and outer surfaces 56b, 56a for engagement with the sealing surface 20, so long as the inner surface 56b configuration of the body directs the fluid pressure PW in the internal chamber in the distal-to-proximal direction to generate a sealing force F2 normal to the sealing surface 20 sufficient to form a fluid tight seal between the body 52 and the sealing surface 20 in a manner as previously described.

In one preferred embodiment of the seal assembly 50, the body 52 is preferably formed of a rubber or elastomeric material, such as for example, ethylene propylene diene monomer (EPDM). Accordingly, one preferred aspect the body 52 is that it is of a sufficient hardness to support the thermally responsive trigger 30 along the preferred sprinkler axis A-A; yet be flexible or compressible enough to allow the seal assembly 50 and its body to be installed, compress, deflect and form the sealed engagement under the various load forces as previously described. Referring to FIGS. 1A, 2 and 4, the elastomeric seal assembly 50 further preferably includes a button 70 disposed between the body 52 and the thermally responsive trigger 30. The button 70 is preferably configured to house the body 52 and provide a seat 74 for the thermally responsive trigger 30 and distribute the loading force of the trigger substantially evenly over the floor 62 of the body 52. More specifically, the button 70 has an upper surface 72a with a first recess 73 having a depth and diameter and sufficient to house the body 52. Moreover, the depth of the first recess 73 to define a preferred wall thickness for insertion or engagement within the annular groove 22, as seen, in FIG. 2. The engagement between the button 70 and the annular groove 22 facilitates centering of the body 52 over the outlet 18b. The button 70 further preferably includes a lower surface that preferably includes a second recess 74 for engaging and seating the proximal end of the thermally responsive trigger 30. More preferably, the second recess 74 is dimensioned with a width and depth sufficient to support one end of a glass bulb 30. Where the end of the preferred bulb 30 is substantially spherical or tear drop in shape, the recess 74 is correspondingly concaved with a diameter and radius of curvature to engage the outer end surface of the bulb 30. In addition to distributing the loading force substantially evenly over the body 52, the button 70 eliminates the need to form a seating recess for the bulb or trigger 30 along the distal outer surface 56a of the body 52.

Alternatively to the inclusion of the button 70, the seal assembly 50 can eliminate the button 70, provided the body 52 is of a sufficient thickness to permit formation of a recess or other surface configurations to seat the end of the thermally responsive trigger 30. As such the body 52 itself provides the seal assembly 50. Further in the alternative, the body can be made of an alternate material, such as for example, metal. An alternative sprinkler assembly 10′ having another preferred embodiment of the seal assembly 250 is shown in FIGS. 2C, 2B, 5 and 5A. The seal assembly 250 includes a body 252 made of metal, such as for example, a nickel, a copper or steel alloy. The body 252 is geometrically configured similar to the body 52 previously described with an inner surface 256b to define the internal chamber 258. The metal body 252 is preferably sufficiently resilient and flexible so that it can be formed, installed, loaded and provide the self-sealing function as described herein; however, it should be understood in certain applications as desired, the metal body 252 can be utilized with the button 70 to provide the seal assembly 50. As shown, the outer surface 256a at the distal end 252b of the body is engaged with the proximal end of the thermally responsive trigger 30. Accordingly, the body 252 is preferably configured with a recess at its distal end 252b for seating the glass bulb 30. The body 252 is further preferably dimensioned such that the proximal end 252a of the body 252 is preferably disposed within the annular groove 22 in order center the body 252 in the absence of a surrounding button housing. Under fluid pressure, a proximal portion of the outer surface 256a forms a sealed engagement with the most proximal surface 20′ of the annular groove 22 as seen in FIG. 5A and in a manner as previously described.

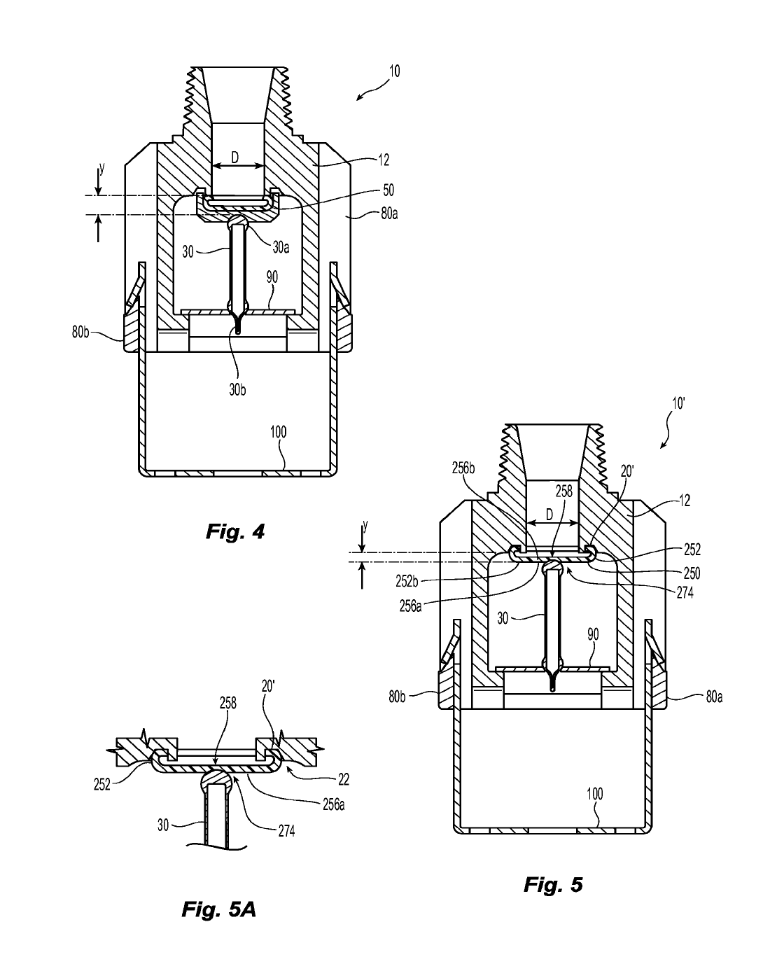

In the manufacture, assembly, and transport of the sprinklers 10, 10′, the preferred seal assemblies 50, 250 form a preferred snap fit between the sealing surface 20 of the sprinkler frame 12 and the thermally responsive trigger 30. The thermally responsive trigger is preferably disposed and substantially axially aligned along the sprinkler axis A-A having a proximal end 30a supported against the seal assembly 50 and a distal end 30b supported by the sprinkler frame 12. With reference to FIGS. 4 and 5, each of the sprinkler assemblies 10, 10′ are shown with a common sprinkler frame 12 and the thermally responsive triggers are shown commonly embodied as a glass bulb 30. In the preferred embodiment, the distal end 30b of the glass bulb 30 is supported by a bridge 90, which is supported by the frame posts or stanchions 80a, 80b, which extend distally from the distal portion 16 of the frame body.

In order to assemble the sprinkler 10, 10′, the seal assembly 50, 250 is inserted between the sealing surface 20 and the glass bulb 30 to form a preferably snap fit relation. With the distal end 30b of the glass bulb 30 disposed within a receiving hole or seat formed in the bridge 90, a gap y is defined between the sealing surface 20 and the proximal end 30a of the glass bulb 30. The uncompressed height of the seal assembly 50 is preferably greater than the gap y. For example, referring to the uncompressed views of the body 52, 252 in FIGS. 2A-2D, the height of the body 252 alone (HΓ) or the height in the assembled combination of body 52 and button 70 (HI), is preferably greater than the gap y. Accordingly, in order to initially load the seal assembly 50 in the assembly of the sprinkler 10, 10′, the seal assembly 50, 250 is compressed for insertion in the gap between the sealing surface 20 and the proximal end 30a of the bulb 30. Upon insertion, the resilience of the body 52, 252 expands the seal assembly 50, 250 to form the preferred snap fit between the sealing surface 20 and the proximal end 30a of the bulb 30. Where the glass bulb 30 is a substantially tubular structure having a tapering and narrow capillary end as seen, for example, in U.S. Pat. No. 4,796,710, which is incorporated by reference in its entirety. Further details of where the glass bulb 30 is a substantially tubular structure having a tapering and narrow capillary end are shown and described in International Application No. PCT/US2014/025034, filed Mar. 12, 2014 (which claims priority to U.S. Provisional Patent Application No. 61/780,840) and is incorporated by reference in its entirety, the opposite substantially spherical or teardrop end defines the proximal end 30a engaged with the seal assembly 50 and the substantially narrow capillary end preferably defines the distal end 30b of the thermally responsive trigger 30 engaged with the bridge 90.

The expansion of the installed resilient body 52 increases the support or engagement between the proximal end 30a of the bulb 30 and the seat 74 of the button 70 in FIG. 4 or the seat 274 of the body 252 of FIG. 5. Referring again to FIGS. 2B, 4 and 5, the maximum diameter DMax of the body 52 is preferably greater than the diameter D of the outlet 18b of the sprinkler frame 12 so as to place a proximal portion of the outer surface 56a of the body 52 in close proximity or adjacent the sealing surface 20. Upon installation, the introduction of pressurized fluid in the internal chamber 58, the fluid tight seal forms preferably between the outer surface of the body 52 and the sealing surface 20 in a manner as previously described.

Because the preferred embodiments of the sprinkler 10, 10′ use an initial snap fit to initially load the glass bulb 30 and seal assembly 50 and then use the internal fluid pressure to form a fluid tight seal at the sealing surface 20, the preferred embodiments of seal assembly 50 can have lower loading requirements over known automatic sprinkler seal assemblies. Thus, the preferred embodiments of sprinkler seal assemblies 50, 250 can eliminate the need for a load screw. The preferred embodiment provides for sprinklers 10, 10′ that includes a non-load-screw thermally responsive trigger. More particularly, the thermally responsive trigger, for example, bulb 30 is used within the sprinklers 10, 10′ without the load screw. Furthermore, as described below, the thermally responsive trigger can be any known arrangement, such as, for example, a lever and soldered link arrangement utilized, however, without a load screw to provide the non-load-screw thermally responsive trigger. However, it should be understood that the described embodiments of the seal assembly can also be used with a thermally responsive trigger and load screw to load and seal the seal assemblies 50, 250. Further details of a load screw to load the sealing and bulb assemblies is shown and described, for example, in International Application No. PCT/US2014/025034, filed Mar. 12, 2014 (which claims priority to U.S. Provisional Patent Application No. 61/780,840) and is incorporated by reference in its entirety.

The sprinkler assemblies 10, 10′ of FIGS. 4 and 5 are shown as drop-down pendent sprinklers, in which the deflector members 100 translate distally upon thermal separation of a concealing escutcheon (not show). In its fully distal position, the deflector 100 is shown supported by the distal ends of the stanchions 80a, 80b of frame 12. The sprinkler frame is preferably formed from a plastic material, such as for example, Chlorinated Polyvinyl Chloride (CPVC) material, more specifically CPVC material per ASTM F442 and substantially similar to the material used to manufacture the BLAZEMASTER® CPVC sprinkler pipe and fittings as shown and described in the technical data sheet, TFP1915: “Blazemaster CPVC Sprinkler Pipe and Fittings Submittal Sheet” (June 2008), which is incorporated by reference in its entirety. However the sprinkler assembly can be formed from other materials such as, for example, cast and machined iron or brass. Additional details of the preferred concealed pendent sprinkler frame 12, deflector 100 and escutcheon are shown and described in the detailed description and figures of International Application No. PCT/US2014/025034, filed Mar. 12, 2014 (which claims priority to U.S. Provisional Patent Application No. 61/780,840) and is incorporated by reference in its entirety. However, it should be understood that the applicability of the preferred seal assembly 50 can be extended to use in other sprinkler frame arrangements and trigger assemblies. Generally, the preferred embodiments of the seal assembly 50 can be used with any sprinkler assembly in which the seal is supported by the thermal trigger, provided the sealing surface of the sprinkler frame and thermal trigger are dimensioned and arranged for insertion of the seal assembly under fluid pressure loading as previously described. Thus, the preferred seal assemblies can be used with sprinkler frames that include: (i) frame arms that extend distally of the frame outlet and are formed integrally with a sprinkler apex; (ii) thermally responsive triggers leveraged or mounted about the sprinkler apex, such as for example, a lever and soldered link arrangement; and/or (iii) a fixed deflector mounted to the apex. For example, the preferred seal assemblies 50, 250 can be used in any one of sprinkler assemblies and trigger assemblies shown in U.S. Pat. Nos. 4,296,815; 6,059,044; 6,976,543; 7,516,800; 8,074,725; 7,201,234; and 8,151,897, and U.S. Patent Publication No. 2010/0263883, each of which are incorporated by reference in their entirety.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1.-26. (canceled)

27. An automatic fire protection sprinkler assembly comprising:
a sprinkler frame having an inlet, an outlet and an internal passageway extending from the inlet and the outlet, the frame including a sealing surface formed about the outlet;
a deflector member spaced from the outlet;
a seal assembly for sealing the internal passageway, the seal assembly including a body having a proximal end, a distal end and a wall circumscribed about a central axis to define an outer surface and an inner surface forming an internal chamber, the inner surface inward from the outer surface relative to the central axis, the wall defining an opening at the proximal end of the body exposing the internal chamber to the internal passageway and a floor at the distal end of the body to enclose the chamber; and
a thermally responsive trigger disposed between the seal assembly and the deflector member to support the seal assembly in the outlet such that a portion of the proximal end of the body engages the sealing surface to form a fluid tight seal with the internal passageway in fluid communication with the internal chamber;
wherein the body of the seal assembly is symmetrical about each of a first plane and a second plane which are perpendicular to one another at an intersection that contains the central axis such that at least one of the first plane and the second plane bisects the body to define a bisected body having an elliptical outer profile.

28. The automatic fire protection sprinkler assembly of claim 27, wherein the wall defines a curve at each end of the profile, the curve having a center of curvature between the proximal end and the distal end.

29. The automatic fire protection sprinkler assembly of claim 28, wherein the curve defines an arc of a circle.

30. The automatic fire protection sprinkler assembly of claim 27, wherein a portion of the outer surface at the proximal end of the body engages the sealing surface such that an internal fluid pressure within the chamber acts on a portion of the inner surface parallel to the portion of the outer surface to define a normal force on the sealing surface.

31. The automatic fire protection sprinkler assembly of claim 27, wherein the seal assembly includes a button having an upper surface and a lower surface, the upper surface including a first recess for housing the body, the lower surface including a second recess for engaging the thermally responsive trigger.

32. The automatic fire protection sprinkler assembly of claim 31, wherein the sprinkler frame has an annular groove formed about the sealing surface, the upper surface of the button being engaged with the annular groove.

33. The automatic fire protection sprinkler assembly of claim 27, wherein the body is made of an elastomeric material.

34. The automatic fire protection sprinkler assembly of claim 27, wherein the body is made of a metal.

35. The automatic fire protection sprinkler assembly of claim 34, wherein the sprinkler frame has an annular groove formed about the sealing surface such that the sealing surface defines the most proximal portion of the annular groove, the proximal portion of a metal body being engaged with the annular groove.

36. An automatic fire protection sprinkler assembly, comprising:
a sprinkler frame having an inlet, an outlet and an internal passageway extending between the inlet and the outlet along a central axis, the frame including a sealing surface formed about the outlet;
a thermally responsive trigger; and
a seal assembly disposed between the sealing surface and the thermally responsive trigger, the seal assembly including a body having an inner surface defining an internal chamber about the central axis, the inner surface inward from the outer surface relative to the central axis, the inner surface including a portion disposed relative to the sealing surface such that a fluid disposed in the internal chamber acts on the portion of the inner surface to define a sealing force in a direction of the sealing surface;
wherein the body of the seal assembly is symmetrical about each of a first plane and a second plane which are perpendicular to one another at an intersection that contains the central axis such that at least one of the first plane and the second plane bisects the body to define a bisected body having an elliptical outer profile.

37. The automatic fire protection sprinkler assembly of claim 36, wherein the body includes an outer surface having a portion adjacent the sealing surface, the sealing force providing a sealed engagement between the portion of the outer surface and the sealing surface.

38. The automatic fire protection sprinkler assembly of claim 37, wherein the body has a proximal end and a distal end, the body having a wall defining the inner surface, the wall defining an opening at the proximal end in communication with the internal chamber.

39. The automatic fire protection sprinkler assembly of claim 38, wherein the wall defines a curve at each end of the profile, the curve having a center of curvature between the proximal end and the distal end.

40. The automatic fire protection sprinkler assembly of claim 39, wherein the curve defines an arc of a circle.

41. The automatic fire protection sprinkler assembly of claim 36, wherein the body comprises an elastomeric material.

42. The automatic fire protection sprinkler assembly of claim 36, wherein the body comprises a metallic material.

43. The automatic fire protection sprinkler assembly of claim 36, wherein the seal assembly further comprises a button having an upper surface and a lower surface, the upper surface including a first recess for housing the body, the lower surface including a second recess for engaging the thermally responsive trigger.

44. The automatic fire protection sprinkler assembly of claim 36, wherein the thermally responsive trigger comprises a non-load-screw thermally responsive trigger.

45. The automatic fire protection sprinkler assembly of claim 36, wherein the thermally responsive trigger includes a glass bulb.
